(19) United States
(12) Patent Application Publication
(10) Pub. No.: US 2024/0388924 A1
(43) Pub. Date: Nov. 21, 2024

(54) WIRELESS COMMUNICATION NETWORK ANALYZER

(71) Applicant: Ekahau Inc., New York, NY (US)

(72) Inventors: Dan Marinescu-Gava, Helsinki (FI); Olli Alanen, Vantaa (FI); Teemu Pulkkinen, Helsinki (FI); Mikko Lauronen, Helsinki (FI); Janne Kurjenniemi, Jyväskylä (FI)

(21) Appl. No.: 18/663,822

(22) Filed: May 14, 2024

Related U.S. Application Data
(60) Provisional application No. 63/502,652, filed on May 16, 2023.

(51) Int. Cl. H04W 16/18; H04W 24/02

(52) U.S. Cl. CPC H04W 16/18; H04W 24/02

(57) ABSTRACT

A method for producing a recommendation for how to arrange a target wireless network. Input data is obtained about a target wireless network, and the input data is analyzed to produce a recommendation for how to arrange the target wireless network. The recommendation when carried out changes an aspect of the target wireless network as measured through or reflected in an indicator. Other aspects are also described and claimed.

### CROSS-REFERENCE TO RELATED APPLICATION

This nonprovisional patent application claims the benefit of the earlier filing date of U.S. Provisional Application No. 63/502,652 filed May 16, 2023.

### FIELD

An aspect of this disclosure relates to electronic hardware and software that assists with designing or optimizing a wireless communication network that is deployed, for instance in a building.

### BACKGROUND

A wireless digital communications network (wireless network) may include computing devices or nodes that communicate with each other using wireless data connections. Each node may have a radio transmitter and/or a radio receiver that communicates with the network over radio frequencies (RF). A wireless local area network (WLAN) links two or more devices through a wireless access point (AP). The AP typically connects to a wired router, a switch, or a hub via an Ethernet cable to obtain access to the Internet. The AP projects a wireless signal (e.g., a Wi-Fi signal) which other nodes that are nearby receive, to communicate with the AP and thereby also give those nodes access to the Internet. A typical wireless network may include one or more APs that provide RF coverage to the nodes of the network over a given region. A multi-band AP has multiple radios, operating in different frequency bands.

A network planning tool is used to assist an owner or administrator of the wireless network to design the network, by for example physically locating the APs in a facility (a given space) and configuring communication settings used by nodes of the wireless network. The network planning tool may obtain measurements made by a separate measurement tool. These are measurements of signals used for wireless communications in the network, and such measurements are then analyzed by the network planning tool to determine whether coverage is sufficient at various locations of the facility in which the wireless network is to be deployed. The network planning tool may help the user determine the number of APs as well as the physical locations of the APs to set the number of APs and their physical area of coverage. The user may, for example, wish to have as few APs as possible that provide a sufficiently large area of coverage.

### SUMMARY

Several aspects of the disclosure here aim to provide wireless network owners and administrators with easy-to-digest, computerized user interface dashboard elements that not only let them see what the negative performance or reliability indicators in their networks are but also present recommendations that are designed to “improve” those indicators, by arranging the wireless network. The recommendations are produced by software for arranging a target wireless network, where the software upon being executed by a processor obtains input data about the target wireless network. The processor may be for example part of any computer system, such as a client-side device that is a node in the network, a web server, one or more processors that are part of a cloud computing system, or a distributed arrangement of multiple processors such as in a client-server system. The processor analyzes the input data to produce one or more recommendations for how to arrange the target wireless network, e.g., re-arrange an existing setup of, or do an initial set up for, the network. The recommendation may be carried out automatically, for example without being first displayed or distributed to a user, or they may be carried out prior to being displayed or presented to the user. When the recommendations are carried out, they should (or are intended to) result in change of an aspect of the network as measured through or reflected in the indicators. In one instance, the method is not part of an initial network planning operation, but rather is performed to survey and improve an existing wireless network. It is expected to provide a better solution for the needs of the network owner or administrator.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the Claims section. Such combinations may have advantages not specifically recited in the above summary.

### BRIEF DESCRIPTION OF THE DRAWINGS

Several aspects of the disclosure here are illustrated by way of example and not by way of limitation in the figures of the accompanying drawings in which like references indicate similar elements. It should be noted that references to “an” or “one” aspect in this disclosure are not necessarily to the same aspect, and they mean at least one. Also, in the interest of conciseness and reducing the total number of figures, a given figure may be used to illustrate the features of more than one aspect of the disclosure, and not all elements in the figure may be required for a given aspect.

FIG. 1 is a block diagram depicting data flow in one instance of a method for producing recommendations for arranging a wireless network.

FIGS. 2-10 are screenshots of an example computerized user interface that presents the recommendations.

### DETAILED DESCRIPTION

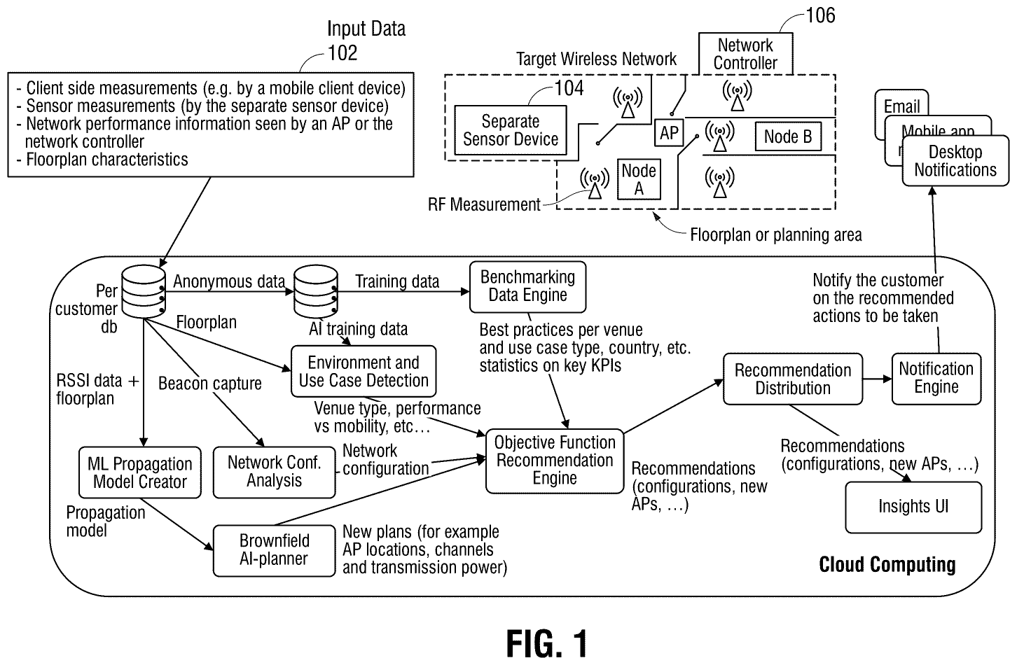

FIG. 1 is a block diagram depicting data flow in one instance of a method for producing recommendations for arranging a target wireless network. In this instance, the method is performed by one or more processors in a cloud computing system, although more generally the method could be performed by other processors. For example, a processor in a client-side device that is a node of the target wireless network may be configured to perform the method. The client-side device may be, e.g., a portable consumer electronics device such as a smartphone, a laptop, or a tablet in whose housing contains or has integrated therein a machine-readable medium such as solid state memory, a radio and a processor that is configured according to instructions stored in the memory. An aspect of the disclosure here thus may be an article of manufacture such as any physical device or system that includes a machine-readable medium having stored therein instructions (such as in the form of a mobile app) that, when executed by a processor, produces one or more recommendations for how to arrange the target wireless network. Note here that the network may be one in which the network data is communicated over-the-air between a radio in a node of the network and an AP in the network, as carried in any one of several available wireless local area network frequency domains or frequency bands including 2.4 GHz, 3.5 GHZ, 5 GHZ, and 6 GHz such as those described in IEEE 802.11x standards. The network may alternatively be a cellular phone network, or it may be a private cellular network such as one that uses the Citizens Broadband Radio Service, CBRS, spectrum.

The method for producing recommendations may proceed as follows. The processor obtains input data 102 about a target wireless network, and then analyzes the input data to produce a recommendation for how to arrange the network, wherein the recommendation changes an aspect of the target wireless network as measured through or reflected in an indicator. A purpose here may be to re-arrange an existing setup of the network, or it may be to do an initial set up of the network. FIG. 1 depicts various forms of the input data 102. The input data may include client-side measurements which are made by a node or client-side device (e.g., node A, or node B) of the network. These may be measurements of a statistical parameter such as received RF signal strength or more generally any signal that is involved in wireless data communications to or from a wireless access point (AP) in the network. Such measurement or other information may include data about or signal measurements of a wireless or over-the-air propagation channel of the network, wherein data is communicated in the channel between a radio in a client-side device (e.g., node A, or node B) and an AP that is part of the network.

Another example of the input data 102 that can be delivered to the processor is measurements made by a separate sensor device 104 that is separate from the node of the wireless network, for example a stand-alone, stationary sensor device placed in a static and known position on the floor plan or planning area of the facility.

The input data 102 delivered to the processor may also be information about network performance as seen by the AP or as seen by a network controller 106, such as faults, channel utilizations, observed interference.

As shown in FIG. 1, the input data 102 may include measurements such as received signal strength indicator (RSSI), packet capture data, RF measurements across the transmission frequencies and across the various radios (where there may be multiple radios in for example a client device, a separate sensor device, or in the AP). The input data 102 may also include floorplan characteristics of the facility in which the network is deployed, either manually input by a user or automatically generated using sensors such as a video camera (not shown). The input data 102 may also include client RSSI, faults and a current network configuration setting as reported by the network controller 106, e.g., a wireless local area network 802.11x network controller.

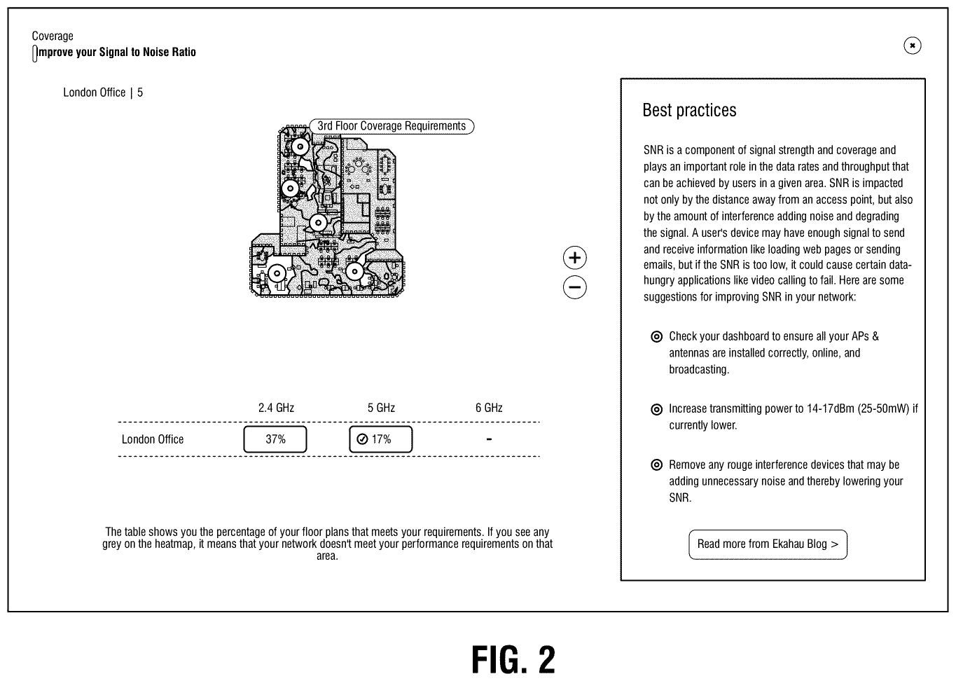

The processor can use various techniques to analyze the input data 102 to determine the recommendations for arranging the network, which can also be referred to as best practices, as shown in the examples of FIGS. 2-10. These techniques may be designed to or are contemplated to produce one or more recommendations that can change an aspect of the network for the better. The techniques may include machine-learning based propagation models, network configuration analysis, a planning program that determines for example AP locations, channels, and transmit powers, environment detection that detects or identifies the type of facility in which the network is deployed (e.g., an office, a warehouse, a hospital), and use case detection (e.g., favoring throughput as compared to latency as compared to mobility).

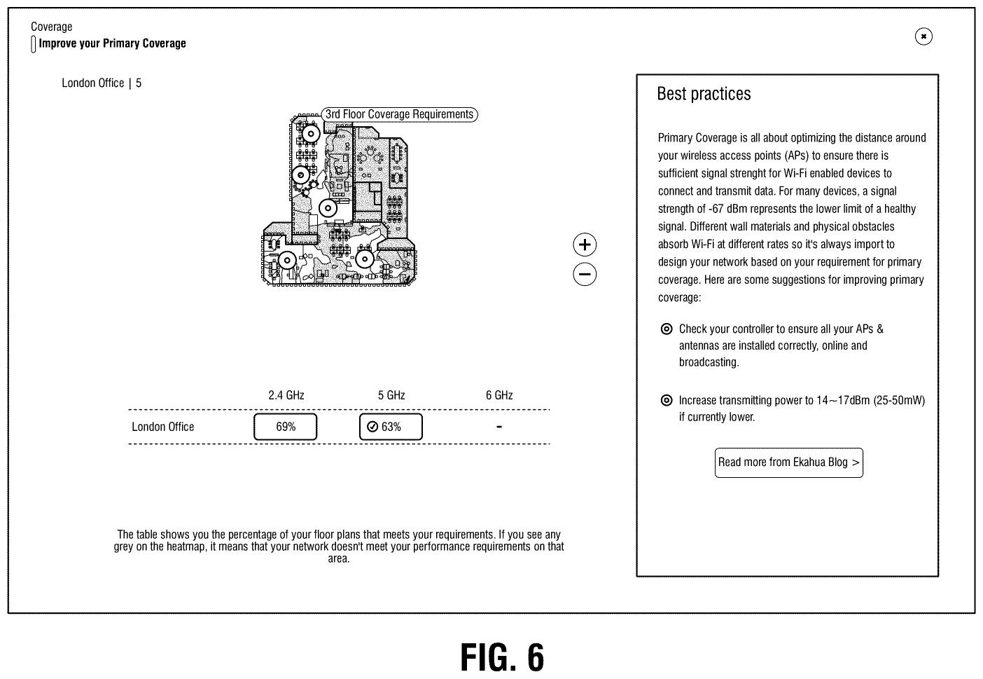

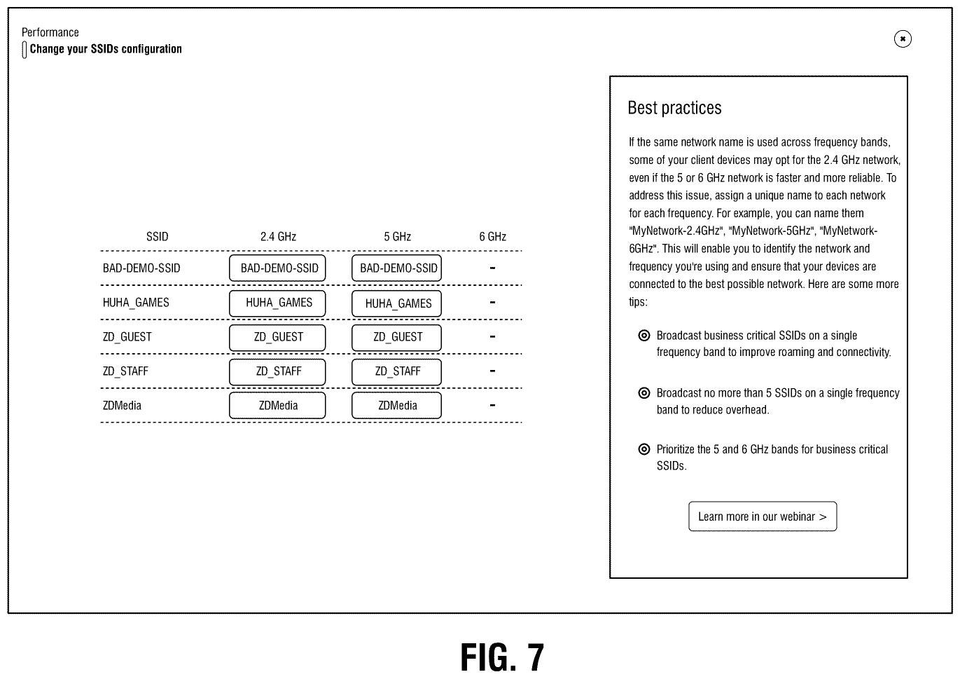

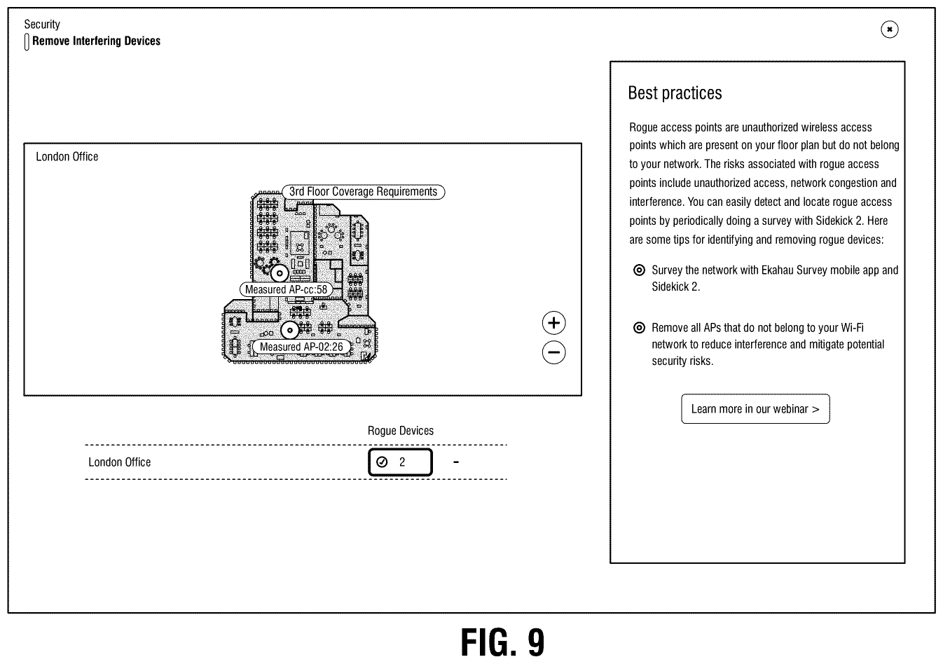

FIGS. 2-10 are screenshots of an example computerized user interface or dashboard that present or display several cases of recommendations to a user, to improve various aspects of the network. These aspects can be measured through or reflected in what is referred to here as indicators. The indicator in most instances negatively impacts wireless data communication, from or to a client-side device which is a node (e.g., the node A or node B) of the network. One or more indicators may be selected from the group consisting of:
communications protocol overhead (e.g., the protocol may be too complex or heavy thereby reducing throughput),
channel contention (e.g., too many client devices are sharing the same channel thereby causing excessive latency or reduced throughput),
compatibility (e.g., a client device being a smartphone can connect to the network but another client device being a laptop is unable to),
connectivity,
latency,
throughput,
coverage (e.g., primary RF coverage, SNR or SNIR-see for example FIG. 6),
performance (e.g., a SSID configuration-see for example FIG. 7, data rates, channel width and beacon overhead),
roaming or mobility (e.g., secondary coverage),
configuration/misconfiguration,
security vulnerability (e.g., management frame protection (MFP) being enabled or disabled, rogue devices (see FIG. 9 where two rogue devices have been discovered), and authentication scheme selection), and
spectrum anomaly (e.g., channel interference or dynamic frequency selection (DFS) channel use).

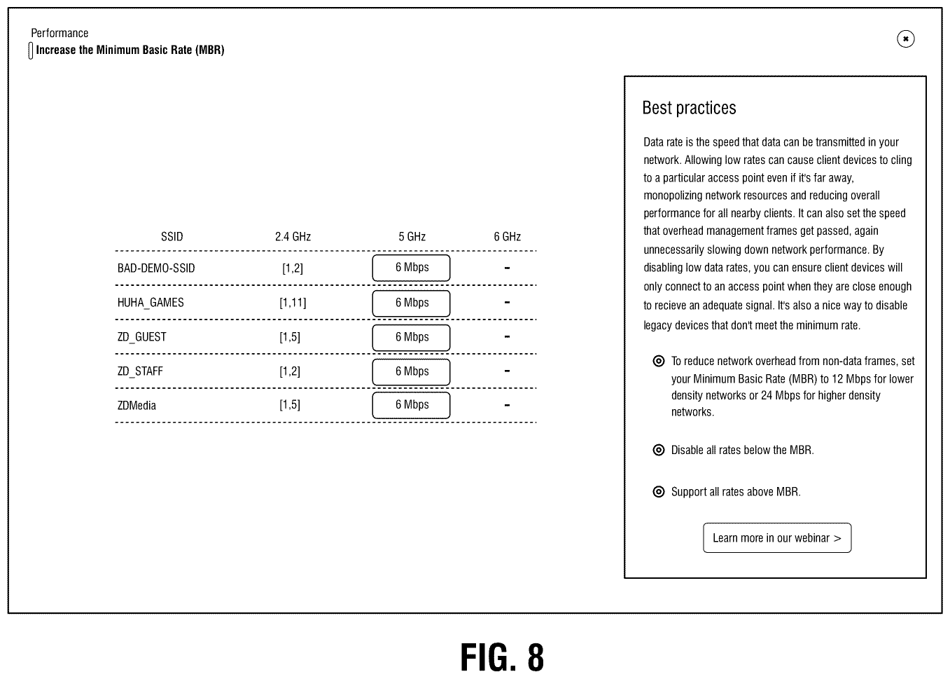

As seen by some of the examples shown in FIGS. 2-10, the recommendations may be one or more of the following:
change to an SSID configuration;
change to a setting such as a security setting;
change to which channels are used for transmission;
change an external antenna of the AP to another one that enables a different transmit or receive beam pattern;
change orientation of the AP or orientation of the external antenna to enable the different transmit or receive beam pattern;
reposition an existing AP of the wireless network;
add another AP to the wireless network (which may already have at least one AP);
change to a network configuration setting that increases transmit power of an existing AP, changes channel width, or changes minimum basic rate (MBR) as seen for example in FIG. 8; and
use a network planning tool to produce a new, wireless network arrangement (a redesign of the network).

To provide a full user experience, it can be seen in FIGS. 2-10 that the description of the recommendation is not only displayed (in this example, positioned to the right of a page, frame, or window) but also accompanies on the same, page, or window, a description of the indicator (which in this example is positioned to the left as seen). This gives a fuller user experience as can see simultaneously not only the indicator but also one or more recommendations that are intended to ameliorate the indicator. Also, there may be multiple indicators shown simultaneously, for instance in FIG. 6 where each indicator is primary coverage in a respective frequency band, or for instance in FIG. 7 where each indicator is the name of an SSID in a respective frequency band and the recommendation is for the user to change the configuration settings so that the business critical SSIDs are on a single frequency band, and to prioritize the 5 GHz and 6 GHz bands for the business critical SSIDs.

FIG. 2 illustrates the case where analysis reveals that the indicator, SNR, is too small, and therefore the recommendation (Best Practices) here is to increase transmit power by a certain amount. Note that there may be more than one recommendation that is produced, to address a given indicator. Carrying out the recommendation here should result in an increase in signal to interference and noise ratio (SINR) or signal to noise ratio (SNR) as a performance proxy.

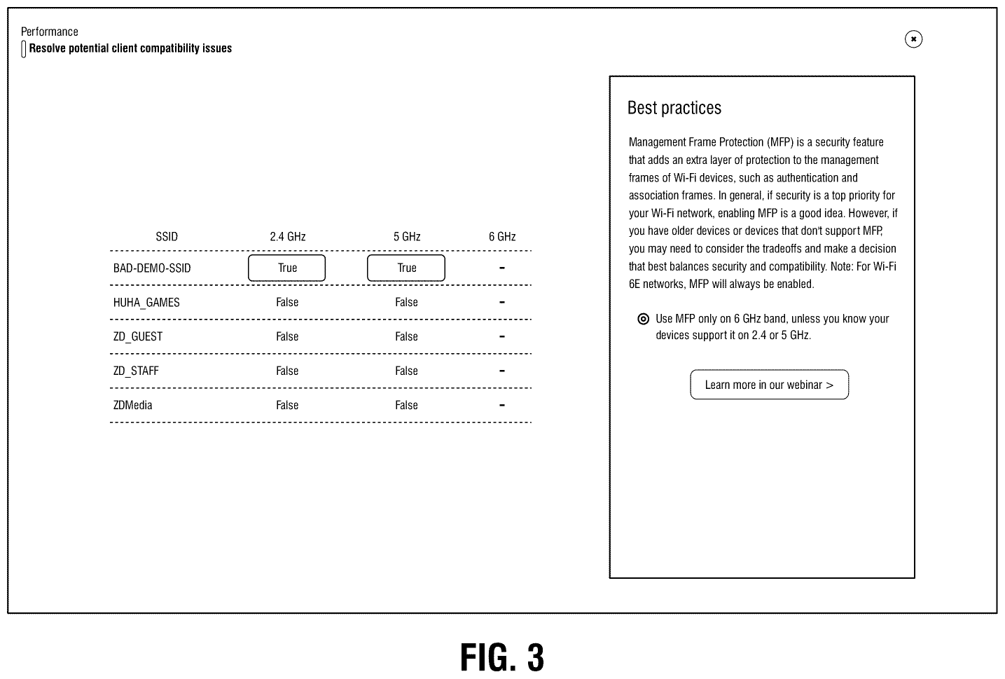

FIG. 3 shows the case where the indicator is a security misconfiguration, and the recommendation to address it is to disable the management frame protection (MFP) except in the 6 Ghz band.

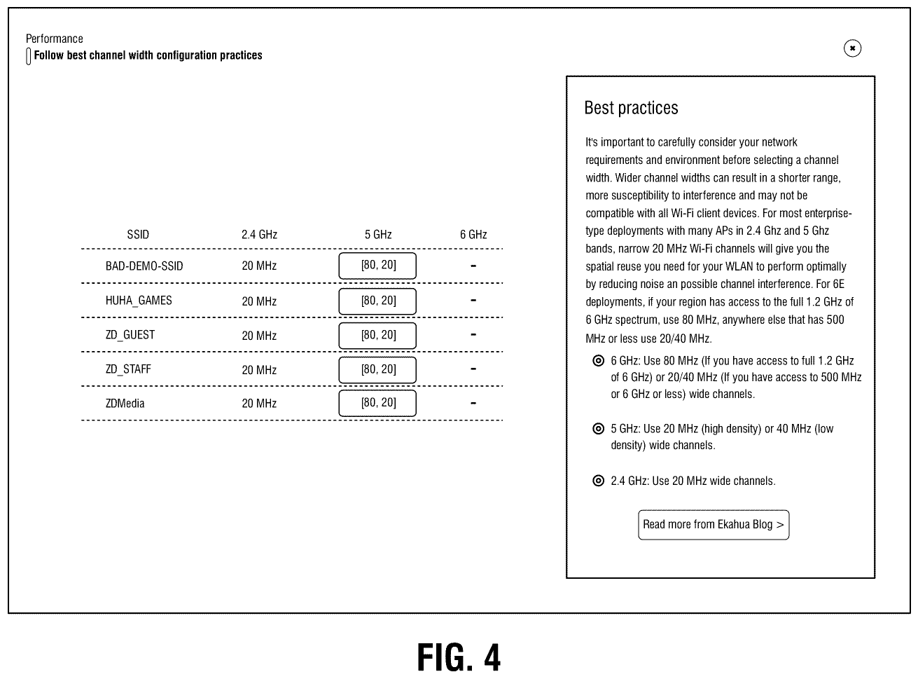

In another example, FIG. 4 illustrates the case where the analysis reveals that there is a misconfiguration in channel width in the 5 Ghz band, and in response the recommendation in this case is for the user to change the network configuration setting for the 5 Ghz band to use either 20 MHz or 40 MHZ (not 80 MHz) wide channels.

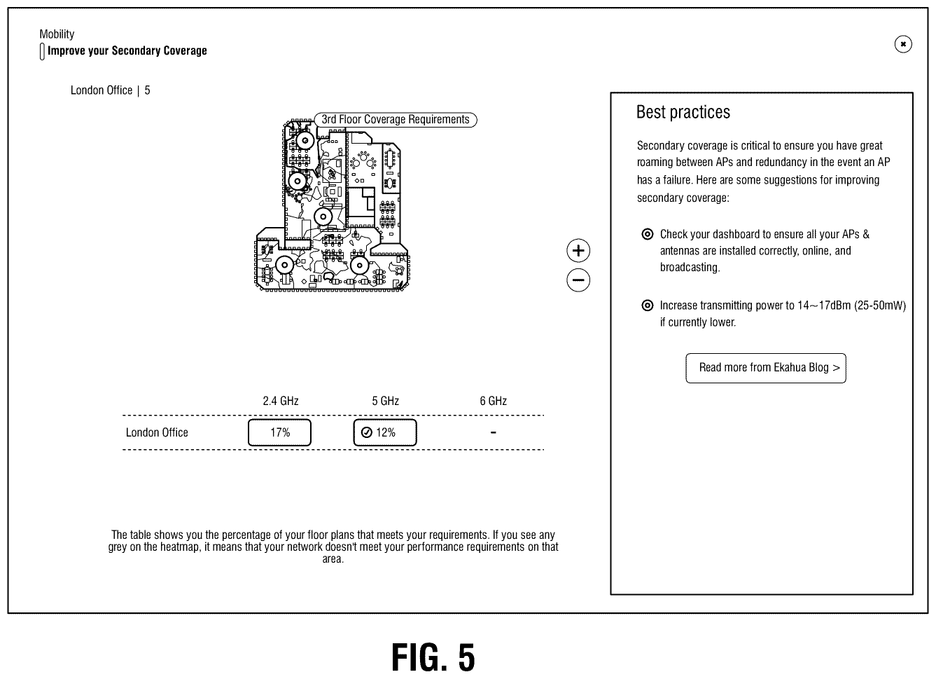

FIG. 5 illustrates the case where the analysis reveals that the indicator secondary coverage is considered too low, and therefore the recommendation in this case (Best Practices) is for the user to check that the APs are installed correctly and to increase transmit power (a network configuration setting for the AP or for a client device). Carrying out this recommendation should result in primary RF coverage or secondary RF coverage changing, preferably increasing.

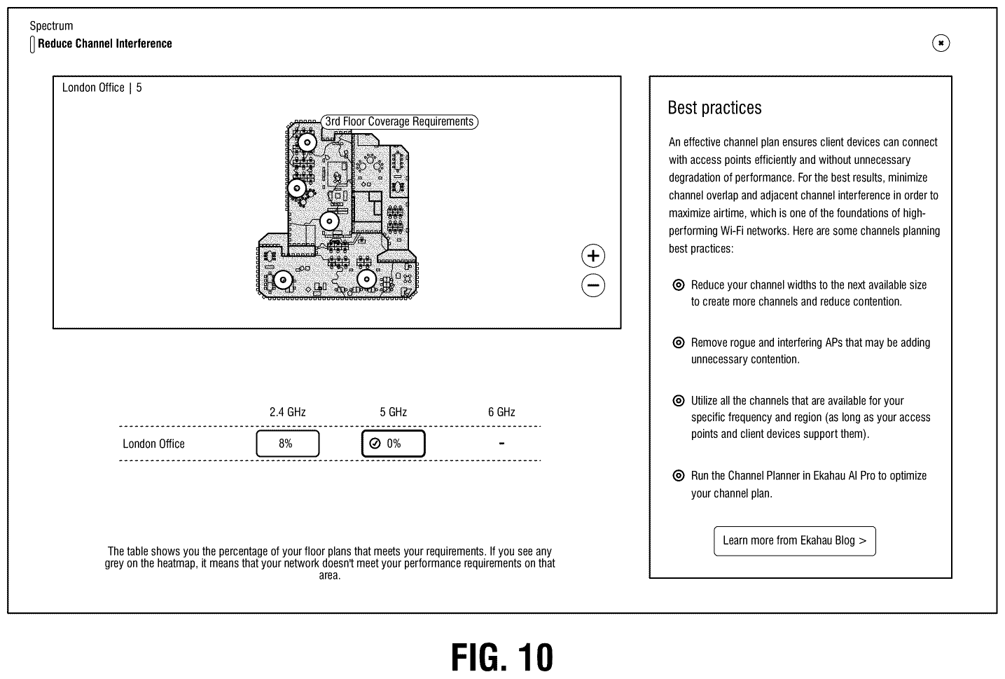

As noted above, where the analysis reveals a particular indicator, a response to address that indicator may take the form of several recommendations-see for example FIG. 10 in which indicator is low primary coverage, and in response four recommendations are given to help increase the primary coverage.

In another aspect, a method that produces the recommendation may also obtain and analyze aggregated anonymized data from wireless networks other than the target wireless network. In other words, the determination of an indicator and the one or more recommendations that are expected to ameliorate that indicator are based not just on the input data but also on this aggregated anonymized data. The aggregated anonymized data may refer to previously made measurements reported by various instances of wireless network monitoring equipment that are being used to collect input data for AP-diverse wireless networks (in which APs are from various vendors) that are in diverse use cases, to estimate what should be the indicators of a “good” network.

In one aspect, analysis of the aggregated anonymized data may enable the recommendation to be of at least two types, namely one that results in the indicator meeting an explicit minimum value defined by a user (e.g., administrator of the network) for a discrete requirement, or it may be one that results in the indicator meeting a best practice value for a “good” network that has been determined using past historical data from various networks (e.g., having different APs, different configurations, or different facility physical layout). In another aspect, the recommendation may result in the indicator meeting either a static minimum value or a dynamic minimum value. The dynamic minimum value is one that is automatically updated or changes, based on computerized analysis of the aggregated anonymized data from wireless networks other than the target wireless network, which include performance measurements that have been observed and collected over time such as two or more weeks or two or more months, of various wireless networks other than the target wireless network.

In yet another aspect, carrying out the recommendation results in the indicator meeting a generic minimum value, or a dynamic minimum value that is defined for a use case. This may supplement the aspects described above where the processor is configured to determine the use case of the wireless network as one of high throughput (e.g., a stationary office, mobility favored (or maximizing roaming ability of client devices), e.g., a warehouse, or latency favored (e.g., a hospital). The recommendations will be different for the same indicator, when the indicator is to meet a generic minimum value versus a dynamic minimum value (the latter being specific to and changing as function of the determined use case).

As seen in FIG. 1, the processor may be further configured to distribute a description of the recommendation (e.g., immediately upon the recommendation being produced) using a cloud based user interface, an email message, a notification in a mobile app, or an alert in a 3d party system.

In yet another aspect, the processor may be further configured to verify whether the recommendation is carried out, by accessing a network configuration setting for example in the client-side device, or by measuring an aspect of the network. In response to the recommendation being carried out, the processor next verifies whether the aspect of the wireless network matches a prediction made using the recommendation and, if it does not match then the process described above of collecting input data and analyzing the input data is repeated to produce a new recommendation. Note here that the match does not have to be an exact match, as there may be a tolerance around how close an observed indicator must be to a predicted indicator (to declare a match).

In yet another aspect, the recommendations that are generated or produced are not displayed or distributed to a user as a proposed course of action, but instead are carried out automatically, without first being displayed or distributed to the user.

While certain aspects have been described above, and shown in the accompanying drawings, it is to be understood that such are merely illustrative of and not restrictive on the broad invention, and that the invention is not limited to the specific constructions and arrangements shown and described, since various other modifications may occur to those of ordinary skill in the art. The description is thus to be regarded as illustrative instead of limiting.

What is claimed is:

1. An article of manufacture comprising a machine-readable medium having stored therein instructions that, when executed by a processor, produces a recommendation for how to arrange a target wireless network, by:
a) obtaining input data about a target wireless network; and
b) analyzing the input data to produce a recommendation for how to arrange the target wireless network, wherein the recommendation changes an aspect of the target wireless network as measured through or reflected in an indicator.

2. The article of manufacture of claim 1 wherein the indicator negatively impacts wireless data communication from or to a client-side device which is a node of the target wireless network, wherein the indicator is selected from a group consisting of: communications protocol overhead, contention, a compatibility issue, a connectivity issue, latency, throughput, a coverage gap, a performance issue, a roaming issue or a mobility issue, a misconfiguration, a security vulnerability, and a spectrum anomaly.

3. The article of manufacture of claim 1 wherein carrying out the recommendation results in primary RF coverage or secondary RF coverage changing.

4. The article of manufacture of claim 1 wherein carrying out the recommendation results in an increase in signal to interference and noise ratio (SINR) or signal to noise ratio (SNR) as a performance proxy.

5. The article of manufacture of claim 1 wherein the recommendation comprises a change to one or more network configuration settings, and carrying out the recommendation results in a decrease in communications protocol overhead caused by the change that causes i) an increase in the indicator when the indicator is throughput, or ii) a decrease in the indicator when the indicator is latency.

6. The article of manufacture of claim 1 wherein carrying out the recommendation results in a decrease in channel contention, due to a smaller number of devices sharing the same channel, which increases a performance indicator.

7. The article of manufacture of claim 1 wherein the instructions configure the processor to produce the recommendation by also obtaining and analyzing aggregated anonymized data from wireless networks other than the target wireless network.

8. The article of manufacture of claim 1 wherein carrying out the recommendation results in the indicator meeting a minimum value or a best practice value.

9. The article of manufacture of claim 1 wherein carrying out the recommendation results in the indicator meeting an explicit minimum value defined by a user for a discrete requirement.

10. The article of manufacture of claim 1 wherein carrying out the recommendation results in the indicator meeting a static minimum value or a dynamic minimum value, both for a specific environment or use case determined to be an office, a warehouse, or a hospital.

11. The article of manufacture of claim 1 wherein the processor is configured to automatically identify a facility in which the target wireless network is deployed, as an office, a warehouse, or a hospital, based on analyzing the input data and analyzing aggregated anonymized data from wireless networks other than the target wireless network.

12. The article of manufacture of claim 10 wherein the dynamic minimum value is automatically updated or changes, based on computerized analysis of aggregated anonymized data from wireless networks other than the target wireless network, which include performance measurements that have been observed and collected over time of various wireless networks other than the target wireless network.

13. The article of manufacture of claim 1 wherein carrying out the recommendation results in the indicator meeting a generic minimum value or a dynamic minimum value that is defined for a use case, wherein the use case is one of a high throughput stationary office, a mobility favored warehouse, or a latency favored hospital.

14. The article of manufacture of claim 1 wherein the processor is configured to determine a use case of the target wireless network as one of: high throughput or a stationary office, mobility favored or maximizing roaming ability of client devices or a warehouse, and latency favored or a hospital.

15. The article of manufacture of claim 13 wherein the generic minimum value or the dynamic minimum value is generated automatically by analyzing the input data, and optionally either with or without requiring user input.

16. The article of manufacture of claim 1 wherein the instructions further configure the processor to:
distribute a description of the recommendation using a cloud based user interface, an email message, a notification in a mobile app, or an alert in a 3d party system.

17. The article of manufacture of claim 1 wherein the instructions further configure the processor to carry out the recommendation by provisioning a configuration change to a network controller.

18. The article of manufacture of claim 17 wherein the provisioning is automatic or does not require user input.

19. The article of manufacture of claim 17 wherein the provisioning is manual based on user input.

20. The article of manufacture of claim 2 wherein the instructions further configure the processor to:
a) verify whether the recommendation is carried out, by accessing a network configuration setting in the client-side device or measuring an aspect of the target wireless network; and
b) in response to the recommendation being carried out, verifying whether the aspect of the target wireless network matches a prediction made using the recommendation and, if it does not match then repeat a)-b) using new input data to produce a new recommendation.
